(19) United States
(12) Patent Application Publication
(10) Pub. No.: US 2011/0121608 A1
(43) Pub. Date: May 26, 2011

(54) BODY FOR A MOTOR VEHICLE

(75) Inventors: Uwe SCHMITZ, Nauheim (DE); Bernd DREYER, Taunusstein (DE); Joachim SCHÄfer, Darmstadt (DE)

(73) Assignee: GM GLOBAL TECHNOLOGY OPERATIONS, INC., Detroit, MI (US)

(21) Appl. No.: 12/884,582

(22) Filed: Sep. 17, 2010

(30) Foreign Application Priority Data
Sep. 17, 2009 (DE) 102009042062.2

(51) Int. Cl. B62D 21/15; B62D 25/10

(52) U.S. Cl. 296/187.09

(57) ABSTRACT

With a body for a motor vehicle with a carrying structure and an engine hood hinged on the carrying structure, the engine hood is supported on the carrying structure through a support crushable in its longitudinal direction.

### CROSS-REFERENCE TO RELATED APPLICATION

This application claims priority to German Patent Application No. 102009042062.2, filed Sep. 17, 2009, which is incorporated herein by reference in its entirety.

### TECHNICAL FIELD

The technical field relates to a body for a motor vehicle and more preferably a design of this body in the proximity of an engine hood offering effective protection against serious head injuries during a collision with a pedestrian.

### BACKGROUND

As a measure for the risk of injury of a pedestrian the so-called Head Impact Criterion HIC has been defined. The bodies of newly developed motor vehicles have to be below predetermined limit values of the HIC in order to be licensed for road use, which can only be achieved with substantial optimization effort. It is particularly difficult to adhere to the HIC limit value both in the event of an impact in the proximity of a support point such as for example a hinge or a buffer of the engine hood and also between the support points. Between the support points the hood can yield but the impacting head is only appreciably decelerated when the hood at the end of its deformation path can no longer yield any further. The attempt to optimize the yield of the hood so that it fulfills the HIC limit value both in a central region, far away from the support points and also in the proximity of the support points is very involved and frequently not successful.

Added to this is that the NCAP program defines two different test bodies for pedestrian safety tests on the engine hood, an adult head of 4.8 kg weight and a child's head of 2.5 kg, and that there are regions of the hood that have to fulfill the HIC specifications for both test bodies. In this region, the hood has to be designed so soft that the permissible acceleration values of the 2.5 kg test body are not exceeded. However, this requires lower deceleration forces and thus a huge deformation travel for the heavier test body with greater impact energy because of the stiffness of the hood which is set correspondingly lower. Since this is not normally available, the heavy and actually less sensitive test body strikes through on to the hard components and structures located under the hood and exceeds the permissible limit values.

There is therefore at least one need for a body construction that makes it possible to adhere to HIC limit values for test bodies of different weight in a same region of the engine hood. In addition, other needs, desirable features and characteristics will become apparent from the subsequent detailed description, and the appended claims, taken in conjunction with the accompanying drawings and this background.

### SUMMARY

The at least one need is solved in that with a body for a motor vehicle with a carrying structure and an engine hood hinged on the carrying structure the engine hood is supported on the carrying structure through a support that can be crushed in its longitudinal direction. In an earlier phase of the head impact the support makes possible the absorption of a large amount of energy; upon commencement of the crushing deformation the resistance force of the support greatly decreases so that it does not substantially contribute to a deceleration of the head which has a major effect on the HIC value during this phase. Through the intense but very short deceleration at the very start of the impact an abrupt stoppage of the head through the striking of the hood against a substantially non-deformable element arranged under said hood such as for example an engine block is avoided.

Preferentially, the support is arranged free-standing, which makes it easier for it to give way to the loading upon impact in lateral direction.

In order to influence the yield of the engine hood over a large area with the help of the support, the support is practically arranged under a reinforcing structure of the engine hood such as a rib, a profile, a frame or the like.

On the carrying structure, the support can practically act above a front wheel, more preferably on a side member spanning a wheel house.

The support can be simply and cost-effectively formed, more preferably cut to size and bent from flat material, more preferably sheet metal. Other materials such as plastic are likewise possible. This allows the production of the support also as an extruded profile or as an injection molded component.

An initially severe and then greatly diminishing deceleration is more preferably achievable with a support that buckles during crushing.

In order for the support to start yielding dependably and reproducibly with a predetermined load, more preferably also in the event of an impact in a central region of the hood not directly supported by the support arranged at an edge of the engine hood, the support is practically designed so that in the crushed state of the support a middle section of the support is deflected away from the middle of the engine hood.

The support preferentially comprises a plurality of plate-like elements extending in the longitudinal direction of the support.

In order to achieve a good relationship of loadability to wall thickness or weight of the support, the plate-like elements are practically arranged in cross section at an angle to one another.

The plate-like elements can mutually support and stiffen one another if among themselves they are connected along bending edges. The connection preferentially is a unitary one. In the buckled state the connected plate-like elements can absorb energy a second time in that the bending edges are pressed flat.

Preferentially, two of the plate-like elements are unitarily connected with another one of the plate-like elements at an edge facing a fender and unconnected at an edge facing an engine compartment. While the edge on the fender side is reinforced through the connection to the other element, the unconnected edge can yield relatively easily under load so that deformation of the support under load at the unconnected edge dependably commences and from there spreads over the entire width of the support.

Practically, the plate-like elements form a profile open in cross section. In this way, the elements normally arranged angularly can align themselves in a line in the buckling region. This reduces to a minimum the deformation resistance of the support after a short phase of high resistance force during which the re-alignment of the elements takes place.

At least one of the plate-like elements should be curved in longitudinal section in order to keep the load threshold, below which deformation of this element commences, low and in order to guarantee reproducible commencement of the deformation under load.

An element relatively severely curved in longitudinal section can practically be flanked by less curved elements on both sides. With the less curved elements the curvature can even disappear. These less curved elements increase the carrying capacity of the support, wherein however the flanking arrangement to the more greatly curved element ensures that the less curved elements buckle reproducibly and subject to the absorption of an amount of energy that can be determined by design.

The curvature of the at least one curved element can be formed through an interruption in a bead oriented in the longitudinal direction of the element.

At an upper end of the support at least two of the plate-like elements are connected to one another through a face plate in order to evenly distribute a load transmitted from the hood over the cross section of the elements.

At a lower end of the support preferentially a strap for fastening to the carrying structure is angled off unitarily.

### BRIEF DESCRIPTION OF THE DRAWINGS

The present invention will hereinafter be described in conjunction with the following drawing figures, wherein like numerals denote like elements, and:

FIG. 1 a view of the front part of a motor vehicle body illustrating the attachment of the support according to an embodiment of the invention;

FIG. 2 a view of a support according to a first embodiment of the invention;

FIG. 3 a view of the support according to a second embodiment; and

FIG. 4 the support after a first crushing step.

### DETAILED DESCRIPTION

The following detailed description is merely exemplary in nature and is not intended to limit application and uses. Furthermore, there is no intention to be bound by any theory presented in the preceding background or summary or the following detailed description.

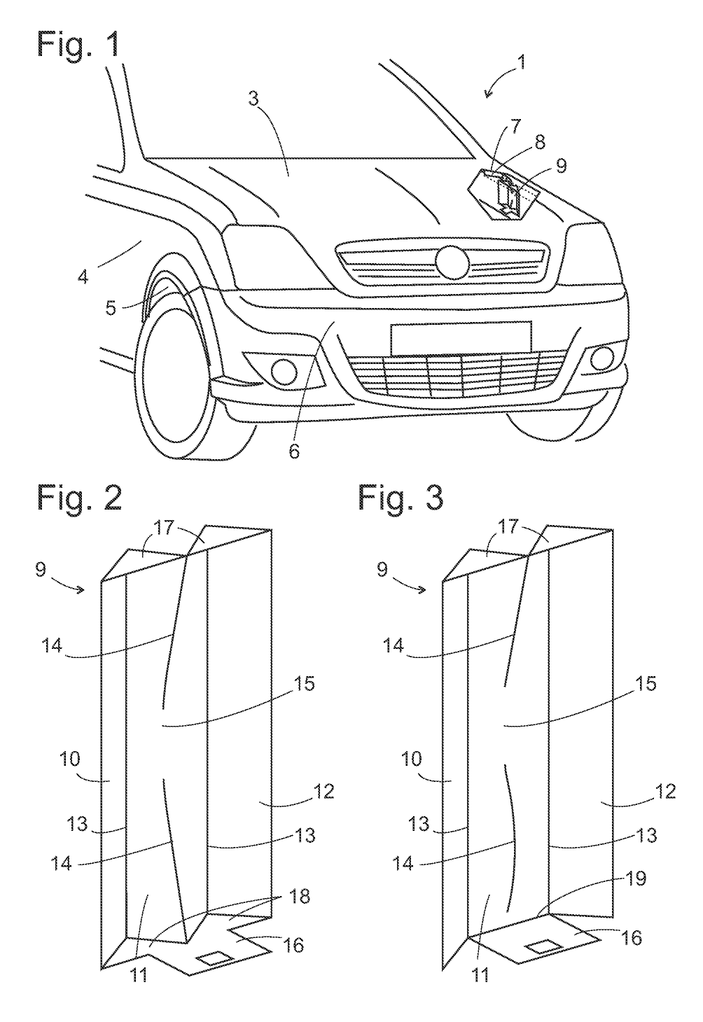

FIG. 1 shows a perspective view of the front region of a motor vehicle body 1 according to an embodiment of the present invention. An engine hood 3 is connected to a stiff carrying structure in a manner known per se via hinges which establish a pivot axis adjacent to its rear edge. The carrying structure in usual manner comprises body parts immoveable upon intended usage such as side members and cross members forming an inner framework, fenders 4, wheelhouses 5, bumpers 6 etc. fastened thereto.

The engine hood 3 partly represented cut open in FIG. 1 comprises likewise in the manner known per se an outer skin 7 of sheet metal and a stiffening frame 8 concealed under the outer skin 7, extending along from its edges and following the course of the edge of the outer skin with struts substantially inverted cup shaped in cross section on which act the hinges at the back and a hood lock at the front.

Through the window cut in the engine hood 3 in the representation of FIG. 1 one of two supports 9 is visible which—concealed under the engine hood 3—are mounted on the two front wheelhouses 5 and, free-standing, extend as far as to immediately below a bottom of the frame 8. Between the upper end of the supports 9 and the frame 8 an air gap can be provided that is sufficient so that vibrations of the engine hood 3, which can occur during normal driving, do not result in striking against the supports 9; it is also conceivable to provide an elastically deformable damping layer between the upper end of the supports 9 and the frame 8 which does not impede the closing of the hood 3 but with closed hood 3 touches both the support 9 as well as the frame 8 and because of this dampens vibrations of the hood 3.

Instead of directly acting on the hood 3 the support 9 according to the invention can also be indirectly effective, for example in that it supports a lid of a box-like installation part below the hood 3, for example a lid of an air filter, a housing of a radiator arranged under the hood 3 or the like, which is situated so closely under the hood that when the hood yields under the impact of a pedestrian it comes in contact with the hood and in the process is likewise dented.

FIG. 2 shows a perspective view of the support 9 according to a first embodiment of the invention. The support 9 formed from a single sheet metal cutting can be substantially divided into three elements 10, 11, 12 extending over its entire height, each of which is unitarily interconnected along vertical buckling or bending edges 13. The two outer elements 10, 12 are aligned in longitudinal direction of the support 9, that is substantially vertically and in longitudinal direction, run along a substantially vertical cut plane substantially in a straight line. In the middle element 11, a vertically oriented bead 14 interrupted at half the height of the support 9 is stamped in. The depth of the bead 14 continuously increases from the interruption 15 toward the top and toward the bottom, which gives the element 11 a curved shape in longitudinal direction. At the lower edge of the element 11 a strap 16 for fastening to the wheelhouse 5 is angled off.

The lateral elements 10, 12 in FIG. 2 are shown exactly in a straight line for the sake of simplicity; however, through the stamping of the bead 14 in the middle element 11 they can likewise be slightly curved in cross section, more preferably along the bending edges 13.

The upper end of the support 9 is formed by two horizontal triangular face plates 17, each of which has an edge connected to the middle element 11 and an edge connected to the outer element 10, 12. The face plates 17 can be molded in one operation with the elements 10, 11, 12 through deep drawing; it is also conceivable to use a sheet metal blank with four triangular straps protruding along the upper edges of the elements 10, 11, 12 and to form the face plates 17 in that in each case two of the straps are angled off, folded over each other and for example connected to each other for example through spot welding.

Corresponding triangular face plates 18 and a strap 16 connected to these and serving for the fastening of the support 9 to the wheelhouse 5 are formed at the lower end of the support 9.

The concave side of the support 9 facing the beholder in FIG. 2 faces the engine compartment in the assembled state, as is evident in FIG. 1.

When the support during an impact is crushed, the middle region of the element 11 yields away from the engine compartment toward the adjacent fender 4. Between the support 9 and the fender 4 a free space, whose width corresponds at least to half the height of the support 9, is kept free so that said support can buckle at the height of the interruption 15 and the legs of the support 9 forming above and below the interruption 15 in the process, can substantially position themselves down flat between the engine hood 3 and the wheelhouse 5. Thus the hood 3 during an impact can practically yield over the entire height of the support 9.

When the support 9 of FIG. 2 buckles, the with the hood 3 upper face plates 17 can turn freely, but not the lower face plates 18 resting on the wheelhouse 5. For this reason folds can form in the elements 10, 11, 12 during buckling which cross the bending edges 13 and the load, at which fold formation commences, can be quite high and vary from case to case. FIG. 3 shows a second configuration of the pillar 9, wherein a strap 16 for fastening to the wheelhouse 5 is connected to a lower edge of the element 11 along a straight bending edge 19. Here, the lower half of the bead 14 reaches its maximum depth at approximately a quarter of the height of the support 9 and with increasing approaching of the bending edge 19 the depth of the bead 14 again tends to zero. If this support 9 yields under load the bending edge 19 is bent open without folds crossing the bending edges 13 being formed. This results in an even, reproducible deceleration effect.

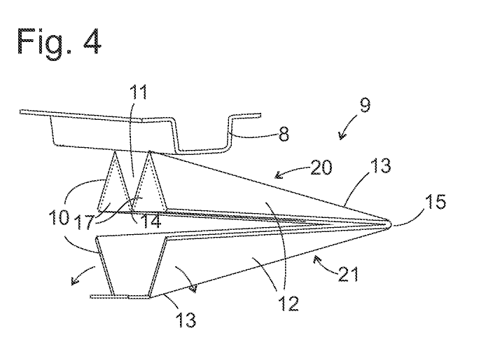

FIG. 4 is a schematic representation of the support 9 in a crushed state which the support 9 adopts more preferably following the impact of the 2.5 kg NCAP test body. The support 9 is buckled at the height of the interruption 15 and forms two legs 20, 21 above and below the buckling zone respectively. At the height of the interruption 15, the bending edges 13 are bent open between the elements 11, 12, 13 so that here the elements 10, 11, 12 lie in a straight line.

At the upper and lower ends of the support 9 the bending edges 13 are still substantially un-deformed. While the stiffness of the support 9 and the hood 3 is dimensioned so that deformation of the support 9 as far as to the configuration shown in FIG. 4 is sufficient to bring the 2.5 kg test body to a standstill, the 4.8 kg test body on reaching this deformation still possesses a substantial amount of kinetic energy. While the upper leg 20 of the support 9 in its shape shown in FIG. 4 is largely stabilized through the triangular face plates 17, there is no such corresponding stabilization on the lower leg 21. Under the pressure of the upper leg 20 the lower leg 21 can therefore still be pressed flat in that the lateral elements 10, 12, as indicated by arrows, yield sideways and downwards under the pressure of the upper leg 20. In the process, the bending edges 13 on the lower leg 21 are pressed flat. Length and material thickness of the bending edges 13 can be suitably selected in order to also absorb the residual kinetic energy of the 4.8 kg test body through their bending open and thus bring said test body to a standstill before the crushing capacity of the support 9 is fully exhausted. This makes possible adherence to the HIC limit values for both test bodies.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A body for a motor vehicle, comprising:
a carrying structure;
an engine hood hinged on the carrying structure;
a crushable support configured to support the engine hood on the carrying structure in a longitudinal direction.

2. The body according to claim 1, wherein the crushable support acts on the carrying structure above a front wheel.

3. The body according to claim 1, wherein the crushable support is formed of a flat material.

4. The body according to claim 1, wherein the crushable support is configured to buckle upon a crushing.

5. The body according to claim 1, wherein in a crushed state of the crushable support a middle section arranged on an edge of the engine hood is deflected away from a middle of the engine hood.

6. The body according to claim 1, wherein the crushable support comprises a plurality of plate-like elements extending in a second longitudinal direction of the crushable support.

7. The body according to claim 1, wherein the crushable support comprises a plurality of plate-like elements arranged angularly in a cross section to each other.

8. The body according to claim 6, wherein the plate-like elements are unitarily connected to along bending edges.

9. The body according to claim 7, wherein at least two plates of the plurality of plate-like elements comprise an edge facing a fender and unitarily connected to another of the plurality of plate-like elements and an edge facing an engine compartment at which the at least two plates of the plurality of plate-like elements are un-connected.

10. The body according to claim 6, wherein at least one of the plate-like elements is curved in a longitudinal section.

11. The body according to claim 10, wherein the at least one of the plate-like elements is flanked on by a less curved element.

12. The body according to claim 10, wherein the at least one of the plate-like elements comprises a bead oriented in a second longitudinal direction and interrupted in a place.

13. The body according to claim 12, wherein an interruption of the bead is provided at half the height of the crushable support.

14. The body according to claim 5, wherein the at least two of the plurality of plate-like elements are connected through a face plate at an upper end of the crushable support.

15. The body according to claim 1, wherein at a lower end of the crushable support a strap configured to fasten to the carrying structure is unitarily angled off.
